(19) United States
(12) Patent Application Publication
(10) Pub. No.: US 2004/0120860 A1
(43) Pub. Date: Jun. 24, 2004

(54) Device and method for the transfer of liquid samples

(76) Inventor: Nikolaus Ingenhoven, Mannedorf (CH)

Correspondence Address: NOTARO AND MICHALOS, 100 DUTCH HILL ROAD, SUITE 110, ORANGEBURG, NY, 10962-2100, US

(21) Appl. No.: 10/474,931

(22) PCT Filed: Dec. 4, 2002
(86) PCT No.: PCT/CH02/00659

(30) Foreign Application Priority Data
Dec. 21, 2001 (CH) 2360/01

(51) Int. Cl. G01N 1/10

(52) U.S. Cl. 422/100; 436/180

(57) ABSTRACT

The present invention relates to a transfer device (1) for removing fluid samples (2) from containers (3) and for introducing these fluid samples (2) into chambers (5) positioned below these containers, the device (1) including an individual chamber (5′, 5″) for each of the containers (3, 3′). Transfer devices (1) according to the present invention are distinguished in that they have enclosure means (4), which include one single individually assigned restriction opening (10), which limits the flow of fluids to be introduced into the containers (3, 3′) or removed from the chambers (5, 5′, 5″), for each container (3, 3′) or for each chamber (5, 5′, 5″). Furthermore, the present invention relates to a method of removing fluid samples (2) from containers (3) and of introducing these fluid samples (2) into chambers (5) positioned below these containers using such a transfer device (1). The device (1) may be used for individually immobilizing fluid samples (2) on MALDI-MS targets (21) and/or for collecting liquid samples in individual collection spaces (12).

The present invention relates to a transfer device and a corresponding method—according to the preamble of independent Claim 1 and according to the preamble of independent Claim 22, respectively—for removing fluid samples from containers and for introducing these fluid samples into chambers positioned under these containers, the device including one individual chamber for each of the containers. This device may, for example, be used for transferring liquids from wells of SPE plates for the solid phase extraction and elution of organic and/or inorganic particles into wells of microplates positioned under them.

In laboratories which are concerned with molecular biological/biochemical assays, the fields of “genomics” or “proteomics” are common terms for the processing and assay of genetic substances, including DNA (deoxyribonucleic acid), RNA (ribonucleic acid), and/or their parts in the form of oligonucleotides or proteins (e.g., in the form of antigens or antibodies and/or their parts in the form of polypeptides). These and similar processes may include multiple work steps in different workstations. The field of proteomics in particular is increasingly gaining in significance, because not only the genome (genetic mass) but rather above all the particular protein configuration present (proteome) determines the appearance and state of a biological organism. This recognition has led to a deeper understanding of the proteins as the actual regulation network taking the place of the dogma of “one gene—one protein—one function”. Proteomics—the quantitative analysis of the proteins present in an organism at a specific point in time and under specific conditions—is therefore being profiled as an important key for functional analysis both in basic research (e.g., for the explanation of reaction and regulation networks) and for applied research (e.g., for searching out and selecting targets for developing medications).

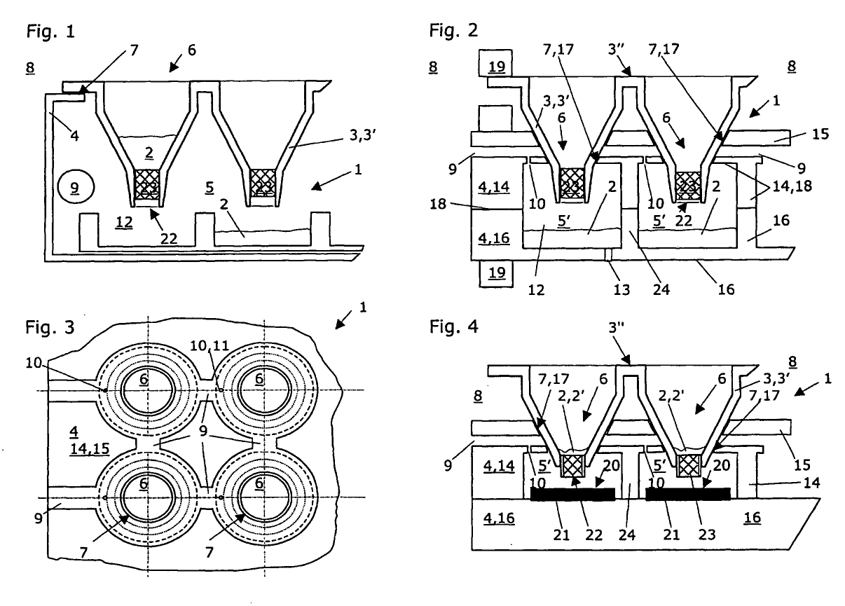

Systems which are capable of performing automated separation or purification methods typically use “SPE plates” (solid phase extraction plates) for processing samples, particularly for solid phase extraction and elution of organic and/or inorganic particles. In this case—depending on the goal of the application—a specific activated filter, a corresponding lattice, or even a separating column in the form of a packed capillary is placed in or at least near the floor outlet opening of a well of a microplate (cf. FIG. 1: SPE plate from the related art). To perform a separation method, a sample is pipetted into a well and, through the application of suction forces (by applying vacuum) or gravity (by centrifuging), is forced to leave the microplate through the filter and/or the lattice via the floor outlet opening.

In the course of this method, the target molecules therefore bind to the activated material, such as the separating column or packing. After performing some wash steps and the particular removal of the wash waste using vacuum or centrifuging, the target molecules and/or the organic and/or inorganic particles separated from the sample in this way may be eluted with the aid of an eluent (a suitable solvent), i.e., separated from the packing, from the filter, and/or from the lattice. Subsequently, the eluted particles are transferred using vacuum or centrifuging into a second microplate or onto the surface of a carrier.

Aspirating the liquids from the SPE plates using partial vacuum or corresponding squeezing using excess pressure is more suitable than centrifuging for automation of this separation or purification method. However, implementing this statement in practice requires overcoming multiple technical obstacles: the separating means used (e.g., filter or lattice) in known SPE plates often has a different flow resistance for the washing agent and the eluate, respectively, so that—if vacuum or a pressurized fluid is used to empty the SPE plates—some wells are emptied more rapidly than others. The flow resistance for the air flowing behind and/or the pressurized liquid is significantly lower in the wells just emptied than the flow resistance for the liquids in the not yet emptied wells; this leads to an undesired and uncontrollable pressure increase in the vacuum and/or to a corresponding pressure drop in the excess pressure system. The emptying of all wells is therefore typically achieved through sudden, abrupt application of a high partial vacuum, which is performed by suddenly opening a valve leading to a pre-evacuated vacuum tank. However, this often leads to spraying or even foaming wash waste material or eluate, which may lead to undesired material transfers into neighboring wells (contamination or cross-contamination) and/or to the loss of one sample, multiple samples, or all samples of a batch. Therefore, depending on the type of microplate used, for example, up to 96, 384, or 1536 samples per batch may be lost.

The object of the present invention is to suggest a transfer device for fluid samples, i.e., a device for aspirating and/or squeezing fluid samples out of containers, which allows the disadvantages of the devices described as the related art to be essentially removed.

This object is achieved—in regard to a first aspect—by a device according to the features of independent Claim 1. In regard to a second aspect, this object is achieved by the use of a transfer device according to the features of Claim 22. Additional features according to the present invention result from the dependent claims.

The advantages of the device according to the present invention and/or the method according to the present invention over the related art include the following:

The smallest bed volumes (packing, filter) may be emptied without loss of sample (e.g., through foaming) from the SPE plates into individual chambers, which are each closed, and individually collected there.

Microplates of practically any construction and size may be used. Such microplates are also known as microtitration plates (trademark of Beckman Coulter Inc., 4300 N. Harbour Blvd., P.O. Box 3100, Fullerton, Calif. 92834, USA) and may include, for example, 96, 384, or 1536 wells.

As an alternative and/or supplement to aspiration, the liquid in the SPE plates may also be driven out and/or squeezed out using overpressure by applying a pressurized fluid, such as air or inert gas.

The following schematic illustrations are to document the known related art. Preferred embodiments of the device according to the present invention are also described on the basis of such figures, without the figures restricting the scope of the present invention.

FIG. 1 shows a vertical partial section through a device for emptying an SPE plate from the related art;

FIG. 2 shows a vertical partial section through a device according to the present invention according to a first embodiment;

FIG. 3 shows a horizontal section through the device according to the present invention according to the first embodiment and/or a second embodiment at the height of the partial vacuum line;

FIG. 4 shows a vertical partial section through a device according to the present invention according to the second embodiment;

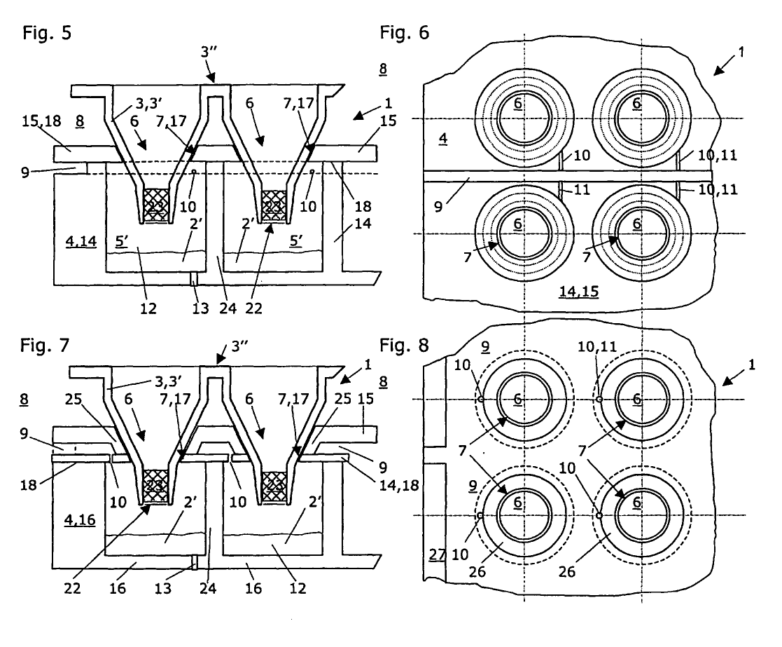

FIG. 5 shows a vertical partial section through a device according to the present invention according to a third embodiment;

FIG. 6 shows a horizontal section through the device according to the present invention according to the third embodiment at the height of the partial vacuum line;

FIG. 7 shows a vertical partial section through a device according to the present invention according to a fourth embodiment;

FIG. 8 shows a horizontal section through the device according to the present invention according to the fourth embodiment at the height of the partial vacuum line;

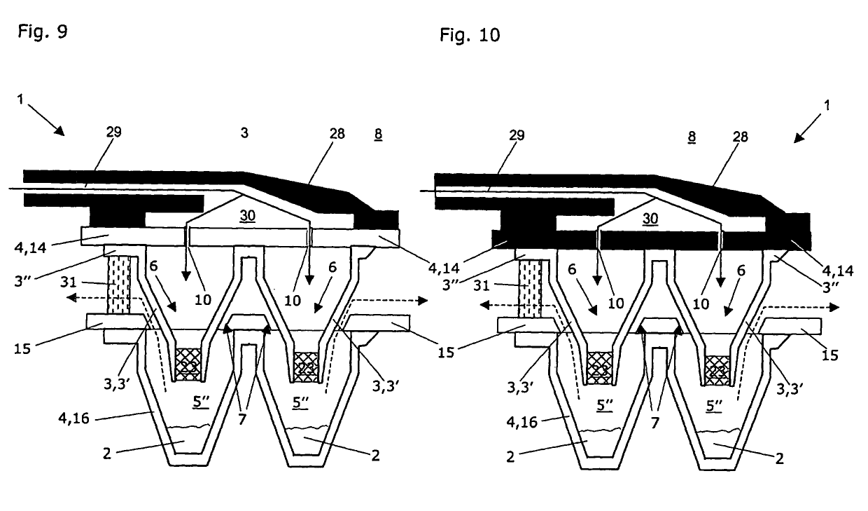

FIG. 9 shows a vertical partial section through a device according to the present invention according to a fifth embodiment;

FIG. 10 shows a vertical partial section through a device according to the present invention according to a sixth embodiment.

FIG. 1 shows a vertical partial section through a device for emptying an SPE plate from the related art. This device 1 is implemented for aspirating fluid samples 2 from containers 3. In the example illustrated, this device 1 is used for aspirating liquids 2′ from wells 3′ of SPE plates 3″. These SPE plates 3″ are implemented for the solid phase extraction and elution of organic and/or inorganic particles. This device from the related art includes a chamber 5, delimited by enclosure means 4, and an intake opening 6, positioned in a part of the enclosure means 4, having an edge region 7. This edge region 7 is sealable to environmental fluids 8 by having at least a part of a container 3, 3′ containing a fluid sample 2, 2′ applied to it. In the context of the present invention, gases, such as nitrogen and other inert gases, as well as air and other gas mixtures, but also liquids or liquid-gas mixtures, which may penetrate into the chamber 5 via a way other than the one provided, i.e., via the lower openings 22 of the SPE plate 3″, are considered environmental fluids. A vacuum line and/or partial vacuum line 9, which leads to the chamber 5 and is connectable to a suction pump (not shown), is provided for evacuating the chamber. A shell divided using intermediate walls is used as a collecting space 12, in whose shell parts the fluid samples 2 leaving the lower openings 22 of the SPE plate 3″ are to be collected. The separating means 23 used (e.g., filter) often have a different flow resistance for the washing agent and/or the eluate, so that in most cases some wells are emptied more rapidly than others. The flow resistance for the air flowing behind, and/or the inert gas flowing behind, is significantly lower in the wells just emptied than the flow resistance in the wells not yet emptied; this leads to an undesired and uncontrollable pressure increase in the vacuum of the chamber 5. As described above, emptying all wells by suddenly, abruptly applying a high partial vacuum may lead to spraying or even foaming wash waste material or eluate and therefore to undesired material transfers into neighboring wells and/or to the loss of one sample, multiple samples, or all samples of a batch. The fluid samples 2 are therefore aspirated into a shared chamber 5, i.e., there is also a shared collection space 12, which is only insufficiently compartmentalized by the collecting shell and/or its subdivisions.

FIG. 2 shows a vertical partial section through a device according to the present invention according to a first embodiment. This device 1 for aspirating fluid samples 2 from containers 3, particularly for aspirating liquids 2′ from wells 3′ of SPE plates 3″ for the solid phase extraction and elution of organic and/or inorganic particles, includes at least one chamber 5 delimited by enclosure means 4 and at least one intake opening 6, positioned in a part of the enclosure means 4, having an edge region 7, which may be sealed to environmental fluids 8 by applying at least a part of a container 3, 3′ containing a fluid sample 2, 2′. Furthermore, this device 1 includes at least one partial vacuum line 9, which leads to the chamber 5 and is connectable to a suction pump, for evacuating the chamber 5. The device 1 according to the present invention is distinguished in that it includes one individual chamber 5′ for each of the containers 3, 3′ and the partial vacuum line 9 is connected via a restriction opening 10—which limits the flow for fluids aspirated from the chamber(s) 5′ and entering the partial vacuum line 9—to the chamber(s) 5′.

In contrast to the device shown from the related art, the fluid samples 2 are now each aspirated into an individual chamber 5′, which is separated from the other chambers, i.e., there is also an individual collection space 12 for each sample, which is completely separated from the other collection spaces. Contamination of the neighboring collection spaces may therefore be practically excluded. The individual connection between the partial vacuum line 9, which—if there are multiple individual chambers 5′—may also be referred to as a partial vacuum collective line, and the individual chamber(s) 5′, is produced in each case by a restriction opening 10. These restriction openings have a diameter and a length which are tailored to one another in such a way that the flow of the fluids aspirated from the individual chamber(s) 5′ and entering the partial vacuum line 9 is limited. In other words: no matter how large the suction force applied and/or the partial vacuum in the partial vacuum line is, the flow of the fluid through this restriction opening is always the same and is only a function of the physical properties of the fluid.

This fluid to be aspirated via the restriction openings 10 is, in the case of the use of the device for aspirating liquids 2′ from wells 3′ of SPE plates 3″ for the solid phase extraction and elution of organic and/or inorganic particles, normally air or an inert gas. The pump (not shown) connected to the partial vacuum line 9 generates a pressure in this line which is below a specific limiting value, which is a function of the geometry of the restriction opening and the physical properties of the fluid to be aspirated. The flow of the fluid through the restriction openings is essentially limited by their geometry, so that setting the pressure and maintaining it is non-critical per se.

The preferred attachment of a “vacuum storage”, i.e., a chamber (not shown), which has a volume multiple times larger than the total volumes of the chambers 5′, restriction openings 10, and the partial vacuum line, prevents the occurrence of sudden pressure surges which are too high. In this way, the partial vacuum may easily be kept constant below the limiting value and the use of a higher-performance and more expensive pump may be dispensed with.

An individual partial vacuum is achieved in each chamber 5′ through the aspiration of the fluid through the restriction openings. This partial vacuum causes the aspiration of the fluid from the containers 3, 3′, until each of these containers is completely emptied and the fluid has arrived with the samples or the washing agent in the individual collection space 12 assigned to each container. The gas flowing behind, which was layered over the samples, also flows through the separating means 23 and reaches the collection space 12, which it then leaves, slowly and in a controlled way, via the restriction opening 10, after which it reaches the partial vacuum line 9. The partial vacuum line 9 is then implemented as a vacuum line.

The device 1 is preferably implemented to receive an SPE plate 3″, the number and distribution of the individual chambers 5′, restriction openings 10, intake openings 6, and/or edge regions 7 corresponding to the particular number and distribution of the wells 3′ of the SPE plate 3″. The device 1 is especially preferably implemented to receive an SPE plate 3″ in the form of a microplate, particularly having 96, 384, or 1536 wells.

However, the fluid to be aspirated via the restriction openings 10 may also be a liquid. The liquid is preferably a system liquid which is immiscible with the fluids to be aspirated from the containers. In such cases, these fluids to be aspirated from the containers may be gases and/or gas mixtures or may also be liquids and/or liquid mixtures. In such cases, the partial vacuum line may be connected to a pump for liquids. This pump may have a reservoir for the system liquid connected downstream from it, so that the system liquid is movable in both directions using the same pump. Therefore, the system liquid—previously for pouring samples into the wells of a microplate—may be pushed up to the surface of the filter and/or separating means 23. The samples may subsequently be charged (e.g., using “on tip touch” delivery using a pipette) and then pulled into the separating means 23 using targeted lowering of the system liquid. In such cases, the device 1 is preferably equipped with emptying openings 13, which are preferably positioned at the lowest point of each individual chamber 5′. The system liquid may be let off in each chamber 5′ via these emptying openings 13 and therefore the chambers 5′ and the partial vacuum line 9 may be completely emptied. After emptying, the partial vacuum line 9, the restriction openings 10, and the chambers 5′ may be flushed and/or dried using a gaseous fluid and the device 1 may thus be prepared for the (already described) aspiration of the washing agent or samples (eluate) from the containers 3, 3′.

The restriction openings 10, which limit the flow of the fluids aspirated from the individual chambers 5′ and entering the partial vacuum line 9, preferably each also include an individually activatable valve 11 for opening and closing the restriction openings. In this way, each container 3 may be emptied not only individually, but also at a specific instant and independently from the other containers, into the collection space 12. This valve may include a tube (made of inert plastic, for example), whose internal cross-section corresponds to the internal cross-section of a restriction opening 10, this internal cross-section preferably able to be reduced, enlarged, or closed using a piezoelement.

The first embodiment of this device according to the present invention is distinguished in that the enclosure means 4 include at least one first plate 14 in which the restriction openings 10 are positioned. This first plate 14 is implemented in such a way that it only partially encloses the individual chambers 5′. This embodiment also includes a second plate 15, which is positioned at least partially parallel to the first plate 14. In addition, the first plate 14 preferably includes the intake openings 6 having first edge regions 7 and second edge regions 7′, the first edge regions 7 being positioned in the first plate 14 and the second edge regions 7′ being positioned in the second plate 15.

The first and second edge regions 7, 7′ together form a contour which essentially corresponds to the outer surface of the container 3′ to be inserted. Through the insertion of a microplate 3″ and/or its wells 3′, the wells 3′ are therefore applied to precisely these first and second edge regions 7, 7′ and therefore seal the individual chambers 5′ against the penetration of environmental fluids. In this exemplary embodiment, the partial vacuum line 9 may be recessed in the first or second plate 14, 15, so that the first or second plate has an essentially flat surface pointed toward the partial vacuum line. Both plates 14, 15 are connected to one another to form a seal, so that there are no leaks in the partial vacuum line.

A third plate 16 forms the individual collection spaces 12 and may be provided with a special inert overcoating (not shown) for this purpose or may be implemented from such material. In the region of the enclosure means 4 and intermediate walls 24, the third plate 16 adjoins the second plate 15 to form a seal.

FIG. 3 shows a horizontal section through the device according to the present invention according to the first and/or second embodiment at the height of the partial vacuum line. In accordance with these embodiments, the partial vacuum line is implemented in the form of a lattice or network, runs annularly around the edge regions 7, and connects these annular regions to straight channels having a larger cross-section. The restriction openings 10 are recognizable as small holes in the region of the annular partial vacuum lines and penetrate the first plate 14 essentially vertically.

FIG. 4 shows a vertical partial section through a device according to the present invention according to the second embodiment. In contrast to the first embodiment (FIG. 2) the first plate 14 forms all essentially vertical walls of the individual chambers 5′ and collection spaces 12. The third plate 16 forms an essentially flat floor on which targets 21 (e.g., for MALDI-MS) may preferably be laid in corresponding depressions or directly onto the flat surface. These individual chambers 5′ have a reduced height, so that the lower openings 22 of the wells 3′ and/or capillaries inserted into these openings may be brought up to a small distance from the surface of the target. In this way, the smallest sample quantities, in the nanoliter or picoliter range, may be applied directly onto these targets.

FIG. 5 shows a vertical partial section through a device according to the present invention according to a third embodiment. In contrast to the first two embodiments shown, the device 1 only includes a first plate 14 and a second plate 15. The first plate 14 completely includes (up to the cover) the individual collection spaces 12 and chambers 5′ and is preferably produced in one piece from injection-molded plastic. The partial vacuum line 9 is recessed into the first plate 14 in this case. The restriction openings 10 may also be recessed in the region adjoining the second plate 15 (not shown) or bored somewhere else in the region of the partial vacuum line. The partial vacuum line may also be incorporated into the first plate using machining. The second plate 15 includes the edge regions 7, which may have the outer surfaces of the container 3′ sealingly applied to them. This second plate 15 is preferably implemented as a flat plate and presses against the walls 4 and/or the intermediate walls 24 of the individual chambers 5′ to form a seal. The collection spaces may be provided with closable emptying openings 13.

FIG. 6 shows a horizontal section through the device according to the present invention according to the third embodiment at the height of the partial vacuum line. The restriction openings 10, which connect the individual chambers 5′ to the partial vacuum line 9, may be clearly seen. These restriction openings 10 may also include an individually activatable valve 11 for closing the restriction openings.

FIG. 7 shows a vertical partial section through a device according to the present invention according to a fourth embodiment. This embodiment includes first, second, and third plates 14, 15, 16. In this case, the first plate 14 is implemented as a simple, essentially flat plate and includes edge regions 7 and restriction openings 10. The second plate 15 is preferably produced as an injection-molded or etched one-piece component and includes the partial vacuum line 9. For insertion of parts of the containers 3′, the second plate 15 has conical depressions 25, which preferably do not have the containers applied to them. The application of the outer surface of the container to form a seal therefore only occurs in the regions 7 of the first plate 14. The third plate 16 includes all walls 4, 24 of the individual chambers 5′ and collection spaces 12 as well as optional emptying openings 13. The second and third plate 15, 16 adjoin the first plate 14 to form a seal.

FIG. 8 shows a horizontal section through the device according to the present invention according to the fourth embodiment at the height of the partial vacuum line. It may be clearly seen from this illustration that the partial vacuum line 9 is implemented as a single coherent cavity which—except for cone-like rings 26 which form the conical depressions 25 and an outer terminal border 27 which extends approximately along the edge of the first plate 14—extends practically over the entire first plate 14. The restriction openings 10 introduced into the first plate connect the individual chambers 5′ in the third plate 16 to the cavity in the second plate 15 acting as the partial vacuum line 9.

FIG. 9 shows a vertical partial section through a device according to the present invention according to a fifth embodiment, in which the chambers 5, 5′ are implemented as wells 5″ of a microplate, particularly having 96, 384, or 1536 wells. The transfer device 1 is implemented for squeezing fluid samples 2 out of containers 3, particularly for squeezing liquids 2′ out of wells 3′ of SPE plates 3″ for the solid phase extraction and elution of organic and/or inorganic particles. This device has, like those shown previously, an individual chamber 5′, 5″ for each of the containers 3, 3′. In addition, this fifth embodiment has enclosure means 4 which include one single individually assigned restriction opening 10 for each container 3, 3′, which limits the flow of the fluids to be introduced into the containers 3, 3′. In this case, the restriction openings 10 are positioned in a first plate 14 and distributed in such a way that each container 3, particularly each well 3′ of the SPE plate 3″ implemented as a multiplate, is assigned an individual chamber and/or an individual well 5″ of a multiplate underneath it.

The two microplates are positioned one over the other in the register and are kept at a distance from one another by a spacer 31. A cover 28 is positioned on the first plate 14, which supplies the wells 3″ with a pressurized fluid 30 via an overpressure line 29 (solid arrows). This pressurized fluid is preferably an inert gas, such as N₂; however, oil-free compressed air or other gases may also be used if they do not enter into any undesired interactions with the samples and/or the eluate. The cavity of the cover 28 is sealed in relation to the first plate 14 in this case, so that the pressurized fluid may only escape through the restriction openings 10. The first plate 14 in turn lies on the SPE plate 3″ to form a seal. The first plate 14 is preferably implemented as a seal and/or made of a soft, gas-impermeable material, which adapts uniformly to the cover 28 and the SPE plate to form a seal.

The pressurized fluid reaches the wells 3″ through the restriction openings 10, which limit the flow of the entering fluid, thanks to their specific dimensions, in such a way that this flow is a function of the physical properties of the pressurized fluid 30 used. This pressurized fluid 30, which is preferably not soluble in the eluate, pushes the eluate out of the wells 3″ and out of the separating means 23, so that the eluate may be collected in the wells 5″ of the lower microplate.

A second plate 15 has expanded intake openings 6, which allow the fluids squeezed out of the lower wells 5″ to escape unhindered (dashed arrows). By narrowing the openings of the lower microplate, the second plate 15 reduces the possibility of contamination of the neighboring well.

FIG. 10 shows a vertical partial section through a device according to the present invention according to a sixth embodiment, in which the chambers 5, 5′ are implemented as wells 5″ of a microplate, particularly having 96, 384, or 1536 wells. The transfer device 1 is implemented for squeezing fluid samples 2 out of containers 3, particularly for squeezing liquids 2′ out of wells 3′ of SPE plates 3″ for the solid phase extraction and elution of organic and/or inorganic particles. This device, like those shown previously, has an individual chamber 5′, 5″ for each of the containers 3, 3′. In addition, this sixth embodiment has enclosure means 4 which include a single, individually assigned restriction opening 10 for each container 3, 3′, which limits the flow of fluids to be introduced into the containers 3, 3′. In contrast to the fifth embodiment shown in FIG. 9, in the sixth embodiment, the cover 28, the overpressure line 29, and the first plate 14 are manufactured in one piece, so that the cover may be lowered onto any arbitrary SPE plate and eluate or wash liquids present in its wells 3′ and/or in its separating means 23 may be squeezed out.

Alternatively (not shown), the SPE plate 3′ may be attached to the cover 28, so that—if the cover 28 is held over the lower microplate using a robot arm or the like—the use of spacers 31 may be dispensed with. A further possibility is to equip the first plate 14 in the sixth embodiment with larger openings which do not impair the flow of the pressurized fluid and to place this pressure cover on a device which has an individual restriction opening 10 for each chamber 5′, 5″ for releasing the fluids from the chambers 5′, 5″.

This modular construction just described allows practically all essential components to be assigned to the plates 14, 15, 16 almost arbitrarily. One skilled in the art will perform such assignments from various points of view, and thus the functional reliability, the production costs, and the ease of maintenance and/or replaceability of the individual parts each play an important role. It is also possible to combine the embodiments 1 to 4 with the embodiments 5 and/or 6, so that eluates or wash liquids may be drawn off or squeezed out and/or simultaneously drawn off and squeezed out, as necessary. In this way, the following arrangements are possible:

A) Aspiration of the eluates or wash liquids is performed from below, one plate (i.e., one enclosure means 4) having restriction openings able to be positioned below or above the SPE plate.

B) Squeezing out of the eluates or wash liquids is performed from above, one plate (i.e., one enclosure means 4) having restriction openings able to be positioned below or above the SPE plate.

C) Suctioning of the eluates or wash liquids from below and squeezing out of the eluates or wash liquids from above are performed simultaneously, one plate (i.e., one enclosure means 4) having restriction openings able to be positioned below or above the SPE plate.

Additional possible improvements and/or combinations result if edge regions 7 include a sealing means 17. Furthermore, possible improvements and/or combinations result if the first plate 14 (cf., e.g., FIG. 7) and/or the second plate 15 (cf., e.g., FIG. 5) are implemented as a seal 18. The device 1 may also include seals 18 which connect the first and/or second and/or third plate 14, 15, 16 to one another to form a seal (cf., e.g., FIGS. 2-8). To improve the sealing effect of such sealing means 17 or seals 18, the device 1 preferably includes additional compression means 19, which are implemented to amplify a sealing connection of the enclosure means 4, 14, 15, 16.

Identical parts are provided with identical reference numbers in the figures, the corresponding names applying in this case even if they are not expressly listed and/or noted in each case. Any arbitrary combinations of the features shown and/or described are a component of the present invention.

Delivery using the capillaries may also be performed directly onto the surface of practically any arbitrary target (e.g., for MALDI-MS, fluorometry, etc.) and is not restricted to subsequent assay using time of flight-mass spectrometry.

1. A transfer device (1) for removing fluid samples (2) from containers (3) and for introducing these fluid samples (2) into chambers (5) positioned below these containers, the device (1) including an individual chamber (5′, 5″) for each of the containers (3, 3′),
characterized in that the device has enclosure means (4), which include one single individually assigned restriction opening (10), which limits the flow of fluids to be introduced into the containers (3, 3′) or removed from the chambers (5,5′,5″), for each container (3, 3′) or for each chamber (5,5′,5″).

2. The transfer device (1) according to claim 1, in which at least a part of the enclosure means (4) includes intake openings (6) having an edge region (7),
characterized in that it is implemented for receiving an SPE plate (3″) for the solid phase extraction and elution of organic and/or inorganic particles, the number and distribution of the individual chambers (5′), restriction openings (10), intake openings (6), and/or edge regions (7) corresponding to the particular number and distribution of the wells (3′) of the SPE plate (3″).

3. The transfer device (1) according to claim 1 or 2,
characterized in that it is implemented to receive an SPE plate (3″) in the form of a microplate having 96, 384, or 1536 wells.

4. The transfer device (1) according to claim 2 or 3,
characterized in that the chambers (5, 5′) are implemented as wells (5″) of a microplate, particularly having 96, 384, or 1536 wells.

5. The transfer device (1) according to one of the preceding claims,
characterized in that the individual chambers (5′) each include a collection space (12) for collecting liquids (2′) aspirated from SPE plates (3″) for the solid phase extraction and elution of organic and/or inorganic particles.

6. The transfer device (1) according to claim 5,
characterized in that the collection spaces (12) include a closable emptying opening (13) for liquids.

7. The transfer device (1) according to one of the preceding claims,
characterized in that the enclosure means (4) include at least one first plate (14) in which the restriction openings (10) are positioned.

8. The transfer device (1) according to claim 7,
characterized in that the first plate (14) also includes the intake openings (6) having the edge regions (7).

9. The transfer device (1) according to claim 7 or 8,
characterized in that the first plate (14) also includes partial vacuum lines (9) and/or at least a part of the individual chambers (5′) and/or at least a part of the collection spaces (12).

10. The transfer device (1) according to claim 7, 8, or 9,
characterized in that the partial vacuum line (9) is connected via one restriction opening (10)—which limits the flow of fluids suctioned out of the chamber(s) (5′) and entering the partial vacuum line (9)—to each of the individual chamber(s) (5′).

11. The transfer device (1) according to claim 7 or 8,
characterized in that the first plate (14) also includes overpressure lines (28) for supplying a pressurized fluid (29) to the containers (3, 3′).

12. The transfer device (1) according to claim 7,
characterized in that the enclosure means (4) also include a second plate (15), which includes the intake openings (6) having the edge regions (7).

13. The transfer device (1) according to one of the preceding claims,
characterized in that the enclosure means (4) also include a third plate (16), which includes at least a part of the individual chambers (5′) and/or at least a part of the collection spaces (12).

14. The transfer device (1) according to claim 13,
characterized in that the third plate (16) includes individually closable emptying openings (13) for liquids.

15. The transfer device (1) according to claim 8 or 12,
characterized in that the edge regions (7) include a sealing means (17).

16. The transfer device (1) according to one of claims 7 through 15,
characterized in that the first plate (14) and/or the second plate (15) are implemented as a seal.

17. The transfer device (1) according to one of claims 12 through 16,
characterized in that it includes a seal (18), which sealingly connects the first and/or second and/or third plate (14, 15, 16) to one another.

18. The transfer device (1) according to one of the preceding claims,
characterized in that it includes compression means (19), which are implemented to amplify a sealing connection of the enclosure means (4, 14, 15, 16).

19. The transfer device (1) according to one of the preceding claims,
characterized in that it includes at least one partial vacuum line (9), which leads to the chamber (5) and is connectable to a suction pump, for evacuating the chamber (5).

20. The transfer device (1) according to claim 19,
characterized in that the edge regions (7) may be sealed to environmental fluids (8) by applying at least a part of a container (3, 3′) containing fluid samples (2, 2′).

21. The transfer device (1) according to one of the preceding claims,
characterized in that the restriction openings (10) each include an individually activatable valve (11) for individually opening and closing each individual restriction opening (10).

22. A method of removing fluid samples (2) from containers (3) and of introducing these fluid samples (2) into chambers (5) positioned under these containers using a transfer device (1), which includes an individual chamber (5′, 5″) for each of the containers (3, 3′),
characterized in that the transfer device (1) has enclosure means (4), which including a single, individually assigned restriction opening (10) for each container (3, 3′) or for each chamber (5, 5′,5″), the flow of fluids to be introduced into the containers (3, 3′) or removed from the chambers (5, 5′, 5″) being limited by these restriction openings (10).

23. The method according to claim 22,
characterized in that liquids (2′) are aspirated and/or squeezed out of wells (3′) of SPE plates (3″) for the solid phase extraction and elution of organic and/or inorganic particles.

24. The method according to claim 22 or 23,
characterized in that the fluid samples (2) are collected individually in individual collection spaces (12) and/or in wells (5″) of a microplate placed underneath.

25. The method according to claim 22 or 23,
characterized in that the fluid samples (2) are individually collected immobilized on surfaces (20), particularly on MALDI-MS targets (21).
